(19) United States
(12) Patent Application Publication
(10) Pub. No.: US 2003/0167338 A1
(43) Pub. Date: Sep. 4, 2003

(54) System and method to provide PPPoE connectivity to non-PPPoE clients

(75) Inventors: David F. Hare, Raleigh, NC (US); Jon A. Yusko, Raleigh, NC (US); Douglas D. Flint, Garner, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 09/683,922

(22) Filed: Mar. 1, 2002

(51) Int. Cl. G06F 15/16

(52) U.S. Cl. 709/236

(57) ABSTRACT

A system and method for providing a virtual Point-to-Point Protocol over Ethernet (PPPoE) session between a client unable to support a PPPoE session and an access concentrator are disclosed herein. A gateway situated between the client and the access concentrator can act as a proxy PPPoE client between the client and the access concentrator, thereby allowing the client to send and receive data to/from the gateway in a protocol supported by the client, and the gateway provides this data to the access concentrator through a PPPoE session initiated and maintained by the gateway. Likewise, data from the access concentrator to the client is transmitted through the PPPoE session to the gateway, and the gateway reformats the data using a protocol supported by the client and then forwards the reformatted data to the client. Additionally, the gateway can be adapted to allow PPPoE-enabled clients to establish PPPoE sessions directly with an access concentrator via the gateway while providing bi-directional communication between an access concentrator and a client not enabled to support PPPoE.

### BACKGROUND OF THE INVENTION

The present invention relates generally to transmitting data between a client and an access concentrator using a Point-to-Point Protocol over Ethernet (PPPoE) session, and more particularly to providing a virtual PPPoE session between a client unable to support a PPPoE session and an access concentrator.

Internet service providers (ISPs) and other high-speed data access service providers face a number of challenges to integrating legacy networks and systems with upgraded last mile access technology and other infrastructure upgrades. Accordingly, a Point-to-Point Protocol over Ethernet (PPPoE) format has been developed to overcome many of these challenges. PPPoE typically allows multiple clients to connect to an access concentrator of an ISP or other service provider using a common gateway device, such as a digital subscriber line (xDSL) modem, a cable modem, a wireless access point, and the like. Additionally, PPPoE allows service providers to utilize access control and to track usage for billing purposes in a manner similar to dial-up services provided using PPP. So while providing for access control and billing services provided by typical PPP services, PPPoE further takes advantage of a relatively high-speed Ethernet network for communication between the one or more clients and the gateway device.

However, while PPPoE provides many advantages, known PPPoE-enabled systems often have limited utility in certain instances. A particular disadvantage of these known systems is that in order to provide a PPPoE session between a client and an access concentrator, the client typically must be adapted to support PPPoE sessions, either through software, hardware, or a combination thereof. However, it may be impractical or impossible for some clients to implement such software or hardware. For example, the resources of the client may be limited, the cost of the PPPoE software/hardware may be prohibitive, a PPPoE software/hardware solution may not be available for a certain client, and the like. Accordingly, such non-PPPoE clients typically would be unable to take advantage of the benefits afforded by PPPoE.

In view of the limitations of known PPPoE implementations, a system and a method for providing PPPoE connectivity to clients without PPPoE support would be advantageous.

### SUMMARY OF THE INVENTION

The disclosed technique mitigates or solves the above-identified limitations in known implementations, as well as other unspecified deficiencies in the known implementations.

The present invention, in one embodiment, provides an interface to a client that is not enabled to support a PPPoE session, where the interface allows for the client to communicate with an access concentrator utilizing the PPPoE protocol. The interface can appear as an asynchronous transfer mode (ATM) interface that supports RFC 1483 encapsulation, as an Ethernet interface, and the like. Likewise, in one embodiment, the present invention allows an application to attach to the bridge as an interface using a media access control (MAC) address different than the MAC addresses associated with the bridge. Likewise, in at least one embodiment, the present invention provides a common interface to both PPPoE-enabled clients and clients not able to support PPPoE.

In at least one embodiment of the present invention, a method for providing data from a client to an access concentrator using a gateway, the method comprising the steps of receiving, at a gateway, a non-PPPoE frame from the client, wherein the non-PPPoE frame includes data intended for receipt by the access concentrator, encapsulating, at the gateway, the first non-PPPoE frame to generate a PPPoE frame, wherein the PPPoE frame includes the data intended for receipt by the access concentrator, and providing the PPPoE frame to the access concentrator from the gateway.

In another embodiment of the present invention a system is provided, the system comprising a first interface adapted to receive a first frame having a non-PPPoE format from a first client and to provide a second frame having a non-PPPoE format to the first client, and a second interface adapted to receive a third frame having a PPPoE format from an access concentrator and to provide a fourth frame having a PPPoE format to the access concentrator. The system further comprises a PPPoE stack adapted to encapsulate the first frame having a non-PPPoE format into the fourth frame having a PPPoE format, and wherein the PPPoE stack further is to deencapsulate the third frame having a PPPoE format into the second frame having a non-PPPoE format and a bridge coupled to the first interface and the second interface, wherein the bridge is adapted to provide the fourth frame to the second interface for output to the access concentrator and to provide the second frame to the first interface for output to the first client. The system additionally comprises an IP stack coupled to the PPPoE stack and the bridge, wherein the IP stack is adapted to route the first frame from the bridge to the PPPoE stack and to route the second frame from the PPPoE stack to the bridge and a frame reflector coupled to the PPPoE stack and the bridge, wherein the frame reflector is adapted to provide the fourth frame to the bridge from the PPPoE stack and to provide the first frame from the bridge to the PPPoE stack.

One objective of the present invention is to allow simultaneous PPPoE connections to a PPPoE access concentrator from at least one client that is not enabled to support a PPPoE session and at least one client that is enabled to support a PPPoE session. Another objective of the present invention is to provide an interface that appears as an ATM interface to applications.

Still further features and advantages of the present invention are identified in the ensuing description, with reference to the drawings identified below.

### BRIEF DESCRIPTION OF THE DRAWINGS

The purposes and advantages of the present invention will be apparent to those of ordinary skill in the art from the following detailed description in conjunction with the appended drawings in which like reference characters are used to indicate like elements, and in which:

FIG. 1 is a block diagram illustrating a system adapted to provide a virtual PPPOE session to a non-PPPoE client in accordance with at least one embodiment of the present invention;

FIG. 2 is a block diagram illustrating a gateway of the system of FIG. 1 in greater detail in accordance with at least one embodiment of the present invention; and

FIG. 3 is a block diagram illustrating a method for routing packets internal to a gateway based on one or more properties of the packets in accordance with at least one embodiment of the present invention.

### DETAILED DESCRIPTION OF THE PREFERRED EMBODIMENTS

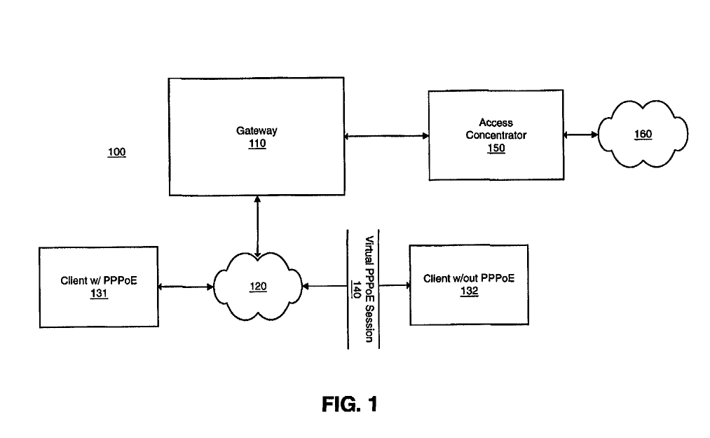

FIGS. 1-3 illustrate a method and a system for providing a virtual point-to-point over Ethernet (PPPOE) session between a client unable to support a PPPoE session and an access concentrator that prefers or requires a PPPoE session. In at least one embodiment, a gateway situated between the client and the access concentrator acts as a proxy PPPoE client between the client and the access concentrator, thereby allowing the client to send and receive data to/from the gateway in a protocol supported by the client, and the gateway provides this data to the access concentrator through a PPPoE session initiated and maintained by the gateway. Likewise, data from the access concentrator to the client are transmitted through the PPPoE session to the gateway, and the gateway encapsulates the data using a protocol supported by the client and then forwards the encapsulated data to the client. Additionally, in at least one embodiment, the gateway is adapted to allow other clients that are PPPoE-enabled to establish PPPoE sessions directly with an access concentrator via the gateway concurrently with non-PPPoE clients.

Referring now to FIG. 1, a system for providing a virtual point-to-point over Ethernet (PPPOE) session between an access concentrator and a non-PPPoE client is illustrated in accordance with at least one embodiment of the present invention. The term non-PPPoE, as used herein, refers to a protocol or format other than a PPPoE protocol or format, such as an Internet Protocol (IP). Likewise, the term non-PPPoE client, as used herein, refers to a client that, for any reason, is incapable of supporting a PPPoE session. Various reasons for why such a client is incapable of supporting a PPPoE session include a lack of the appropriate software, limited client resources, prohibitive cost of PPPoE software/hardware, legacy operating systems that are difficult to retrofit to support PPPoE standards, and the like.

In the illustrated embodiment, the system 100 includes a gateway 110, an access concentrator 150, a network 120, and at least one client 132. The system 100 further can include at least one client 131. The gateway 110 can include any of a variety of devices used as gateways or interfaces between different networks or network components, such as a router, gateway, access point, digital subscriber line (xDSL) modem, cable modem, and the like. For ease of discussion, the gateway 110 will be discussed herein in the context of a DSL modem, also known as an asynchronous DSL termination unit—remote (ATU-R). The access concentrator 150 can include any of a variety of devices adapted to provide network access to one or more remote clients, such as a remote access server or server application, a DSL access multiplexer (DSLAM), an asynchronous DSL termination unit—central (ATU-C), a service provider, a modem or modem bank, and the like. The network 120 can include any variety and combination of communications networks, such as a local area network (LAN), a wide area network (WAN), a private network, the Internet, and the like, and may include a combination of wireless and land-based networks. Alternatively, in at least one embodiment, the network 120 can include other types of connections, such as a universal serial bus (USB) connection, without departing from the spirit or the scope of the present invention. For ease of discussion, a preferred embodiment wherein the network 120 includes a LAN utilizing an Ethernet protocol is discussed herein. The clients 131, 132 can include any of a variety of networked information handling devices, such as a personal computer, a laptop computer, a networked personal digital assistant, a wireless phone, and the like.

In at least one embodiment, the system 100 is utilized to facilitate concurrent communication between the clients 131, 132 and a network 160 via the network 120, the gateway 110 and the access concentrator 150, where the network 120 can include any of a variety of networks, such as a LAN, a WAN, a private network, a wireless network, a private netowork, the Internet and the like. To illustrate, the clients 131, 132 can include personal computers (PCs) used to navigate the Internet (one embodiment of network 160), such as by browsing the World Wide Web (WWW) using a hypertext markup language (HTML) browser installed on the clients 131, 132. In this example, the clients 131, 132 can submit web page requests to servers on the Internet via a DSL modem (one embodiment of gateway 110) and the access concentrator 150. Data representing these requests is first transmitted from client to the DSL modem, where the data is encapsulated in compliance with a protocol, such as a RFC 1483-compliant protocol, appropriate for transmission via the transmission medium, such as the plain old telephone system (POTS), between the gateway 110 and the access concentrator 110. The DSL modem then transmits this encapsulated data through an asynchronous transfer mode (ATM) permanent virtual circuit (PVC) to the access concentrator 150. The access concentrator 150 then can deencapsulate/encapsulate the data, if necessary, and transmit the data over the Internet to one or more intended data servers. Likewise, the requested web page data from a data server is provided to the clients in a reverse manner.

In at least one embodiment, the data transmitted between the gateway 110 and the access concentrator 150 preferably is sent as part of a PPPoE session, whereby the data is encapsulated in accordance with a PPPoE-compliant protocol. This arrangement has a number of advantages for an operator of the access concentrator 150. For one, PPPoE sessions typically allow the operator to determine the connection time of each client, thereby allowing for client billing based on usage. Likewise, since the client typically logs on each time the client uses access concentrator 150 to initiate a PPPoE session, the access concentrator can dynamically assign IP addresses, thereby more efficiently utilizing an assigned block of IP addresses, which often are a scant resource.

In order to establish a PPPoE session between a client and the access concentrator 150, known systems typically include clients having software/hardware adapted to support PPPoE sessions, this software/hardware also known as a PPPoE client. Using the PPPoE client operating on the client, the client initiates a PPP session with the access concentrator via a gateway. The data to be sent to the access concentrator is encapsulated in PPP frames and a PPPoE header and/or other appropriate data is added to PPP frames to generate PPPoE-compliant frames. The PPPoE frames then are transmitted to a gateway, which then routes the PPPoE frames to the access concentrator. Likewise, the access concentrator returns data meant for the PPPoE-enabled client as PPPoE frames, where the PPPoE client on the client strips the PPPoE and PPP header/other data to extract the encapsulated data meant for the client. The client 131 illustrated in FIG. 1 is intended to represent such a PPPoE-enabled client. The client 131 typically includes a networked processing device adapted to support a PPPoE session with the access concentrator 150 via the gateway 110. For example, the client 131 could include a personal computer operating PPPoE client software.

Unlike the client 131, in the illustrated embodiment, the client 132 includes a networked processing device that does not have the capacity to support a PPPoE session with the access concentrator 150 (herein referred to as a non-PPPoE client). This could be for any number of reasons, such as limited computing resources, incompatibility of available PPPoE client software with the underlying architecture of the client 132, or a prohibitive cost of implementing a PPPoE client on the client 132. Regardless of the reason, without the ability to support a PPPoE session when required by the access concentrator 150, the non-PPPoE client 132 typically would be unable communicate with the access concentrator 150 using known systems and methods. However, in accordance with at least one embodiment of the present invention, the gateway 110 includes a mechanism to provide a virtual PPPoE session 140 between the client 132 and the access concentrator 150, thereby allowing the client 132 to communicate with the access concentrator 150 via the gateway 110 even though the client 132 is not adapted to support a PPPoE session.

In at least one embodiment, the virtual PPPoE session 140 allows the client 132 to transmit data to the gateway 110 using a protocol supported by the client 132, such as an internet protocol (IP). In turn, the gateway 110, as a proxy for the client 132, initiates a PPPoE session with the access concentrator 150. The client 132 provides data to the gateway 110 in a format supported by the client 132 and the gateway 110 encapsulates this data into PPPoE-compliant frames and provides these PPPoE frames to the access concentrator 150. Likewise, the access concentrator 150 provides data intended for receipt by the client 132 as PPPoE-compliant frames to the gateway 110. The gateway 110 then deencapsulates the data of the PPPoE frames and then encapuslates the data into using a protocol supported by the client 132 and provides these reencapsulated frames to the client over the network 120. Accordingly, by providing this virtual PPPoE session 140 between the client 132 and the access concentrator 150, the gateway 110 can satisfy the different communication formats of both the access concentrator 150 (PPPoE) and the client 132 (non-PPPoE) without necessitating the installation of additional software or hardware on either end, thereby allowing non-PPPoE enabled clients to communicate with the access concentrator 150.

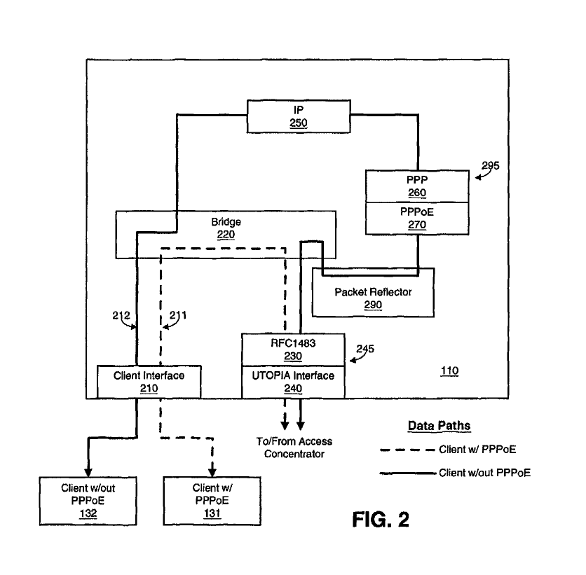

Referring now to FIG. 2, one exemplary configuration of the gateway 110 is illustrated in greater detail in accordance with at least one embodiment of the present invention. The gateway 110, as illustrated, includes at least one client interface 210, a bridge 220, a concentrator interface 245, an IP stack 250, a frame reflector 290, and a virtual PPPoE stack 295. Other components common to gateways, such as power supplies, processors, and data buses, are omitted for ease of illustration. Although the client interface 210 can include any of a variety of communications interfaces, in the illustrated embodiment, the client interface 210 includes an Ethernet-compliant interface The bridge 220 can include any of a variety of bridges implemented in software, hardware, or a combination thereof. For example, the bridge 220 can include a transparent bridge, a spanning tree bridge, and the like. The concentrator interface 245 can include any of a variety of communications interfaces compatible with access concentrators, or a combination thereof.

In the illustrated embodiment, the concentrator interface 245 includes a RFC 1483 interface 230 and a UTOPIA interface 240 to provide a digital subscriber line (xDSL) connection between the gateway 110 and an access concentrator. In the event that a plurality of access concentrators are interfaced using the gateway 110, the gateway 110 can include a single concentrator interface 245 to interface with all respective access concentrators or the gateway 110 can include multiple concentrator interfaces 245, each to interface with one or more of the plurality of access concentrators. The PPPoE stack 295, in one embodiment, includes a PPP client layer 260 and a PPPoE client layer 270.

As discussed previously, in at least one embodiment, the clients 131, 132 utilize the gateway 110 to interface in a bi-directional manner with one or more access concentrators and the one or more networks connected to the one or more access concentrators. The hatched line 211 illustrates essentially a direct, uninterrupted data flow path between the client 131 and one or more access concentrators through gateway 110. The solid line 212 illustrates a flow path between the client 132 and one or more access concentrators via the gateway 110, wherein the bridge 220 routes data through the PPPoE stack 295 for any necessary deencapsulation/encapsulation.

The client 131, which is adapted to support a PPPoE session, can initiate such a session with an access concentrator via the gateway 110 and forward all outgoing data to the access concentrator using the gateway 110 and receive all incoming data intended for the client 131 through the gateway 110 via the PPPoE session. As illustrated, because the data to/from the client 131 is encapsulated in compliance with a PPPoE protocol, the data generally can be forwarded between the client interface 210 and the concentrator interface 245 by the bridge 220 without any additional modification or encapsulation by the gateway 110 to ensure that the data is PPPoE-compliant.

Accordingly, for an incoming PPPoE frame from the client 131, the bridge 220 forwards the PPPoE frame to the concentrator interface 245, wherein it is encapsulated in accordance with the RFC 1483 specification by the RFC 1483 interface 230, formatted at the physical layer by the UTOPIA interface 240 for transmission over a DSL medium, and then transmitted for reception by the access concentrator. Likewise, data intended for the client 131 is transmitted as one or more PPPoE frames to the gateway 110 via the concentrator interface 245, and provided to the bridge 220. The bridge 220, noting the destination of the PPPoE frame, forwards the PPPoE frame to the client interface 210, wherein the PPPoE frame then is forwarded to the client 131 for processing.

Since the client 132 is unable to directly support a PPPoE session, data from the client 132, in one embodiment, takes a different path between the client interface 210 and the concentrator interface 245 compared to data from the client 131. Accordingly, the client 132 provides data to the client interface 110 in a non-PPPoE format, such as an IP packet encapsulated in an Ethernet frame (IPoE). The client interface 110 passes the frame to the bridge 220. The bridge 220 then can extract the IP packet from the frame and forward the IP packet to the IP stack 250 rather than to the concentrator interface 245. The IP stack 250, noting the destination address of the IP packet, forwards the IP packet to the PPPoE stack 295. As such, the IP stack 250 acts as a router between the bridge 220 and the PPPoE stack 295 by routing the IP packet to the PPP client layer 260, wherein the IP packet is encapsulated in a PPP frame. The PPP frame is then provided to the PPPoE client layer 270, wherein a PPPoE header and any other necessary data are added to the PPP frame to generate a PPPoE-compliant frame. Some or all of the elements of the PPPoE stack 295 preferably are implemented as a protocol stack or device driver, similar to a TCP/IP protocol stack, an Ethernet driver, and the like. Implementation of such protocol stacks is well known to those skilled in the art.

The PPPoE frame is then provided to the frame reflector 290. The frame reflector 290, in one embodiment, attaches to the bridge 220 with a MAC address. Accordingly, frames can be provided from the bridge 220 to the PPPoE stack 295 using the frame reflector 290. Likewise, the frame reflector 290, in one embodiment, provides frames from the PPPoE stack 295 to the bridge 220, whereupon the packets are provided to the concentrator interface 245 for any necessary encapsulation and subsequent output to the intended access concentrator.

Conversely, in at least one embodiment, a PPPoE frame transmitted from an access concentrator destined for the client 132 is received by the concentrator interface 245, whereupon it is provided to the bridge 220. The bridge 220, noting the intended destination, forwards the PPPoE frame to the frame reflector 290. The frame reflector 290, by attaching to the bridge 220 with a MAC address, can act as a conduit between the bridge 220 and the PPPoE stack 295, provides the packet to the PPPoE stack 295. The PPPoE stack 295 then can extract the encapsulated IP packet from the PPPoE frame using the PPPoE client layer 270 and the PPP client layer 260. The IP packet then is provided to the IP stack 250. The IP stack 250, noting the intended destination of the IP packet, routes the revised packet to the bridge 220. The bridge 220 then forwards the packet as a frame to the client interface 210. The client interface 210 performs any necessary encapsulation of the frame and then transmits it over an Ethernet-based transmission medium (one embodiment of the network 120 of FIG. 1) for reception by the client 132. Although the PPPoE header and the PPP format data typically are removed from the frame before it is provided to the client 132, in some instances, the PPP data may be retained in the frame as it is provided to the client 132.

Prior to transmission of data between the gateway 110 and the access concentrator 150 on behalf of the client 132, in one embodiment, the PPP client layer 260 initiates a PPPoE session with the access concentrator 150 for the client 132. As part of the PPPoE discovery stage, the access concentrator 150 can generate a unique session ID associated with the client 132 and provide this session ID to the PPP client layer 260. This session ID can be associated with each subsequent outgoing frame processed by the PPP client layer 260 for the client 132. Using this unique session ID, the PPP client can be adapted to initiate and maintain multiple PPPoE sessions on behalf of multiple clients 132. Each client 132 is given a unique session ID that can be used by the access concentrator 150 and the PPP client layer 260 to determine the source/destination of a particular frame. Mechanisms for initiating and maintaining single and multiple PPPoE sessions are known to those skilled in the art.

By using the bridge 220, the frame reflector 290, and the PPPoE stack 295 to provide a virtual PPPoE session between the client 132 and the access concentrator 150, the gateway 110 can encapsulate data from the client 132 to be compatible with the PPPoE protocol and then provide the encapsulated data to an access concentrator while allowing PPPoE-conformant data from the client 131 to be transmitted to the same and/or different access concentrator(s) with minimal processing. Likewise, an access concentrator can provide data intended for receipt by the client 132 to the gateway 110 as PPPoE frames, whereupon the gateway 110 deencapsulates the PPPoE frames to generate non-PPPoE (e.g., IP) packets having a format supported by the client 132. Each of the bridge 220, the frame reflector 290 and the PPPoE stack 295 can be implemented as executable instructions, hardware, or a combination thereof. For example, the PPPoE stack 295 and frame reflector 290 could be implemented as software executed on a processor associated with the gateway 110, and the bridge 220 could be implemented as a hardware device.

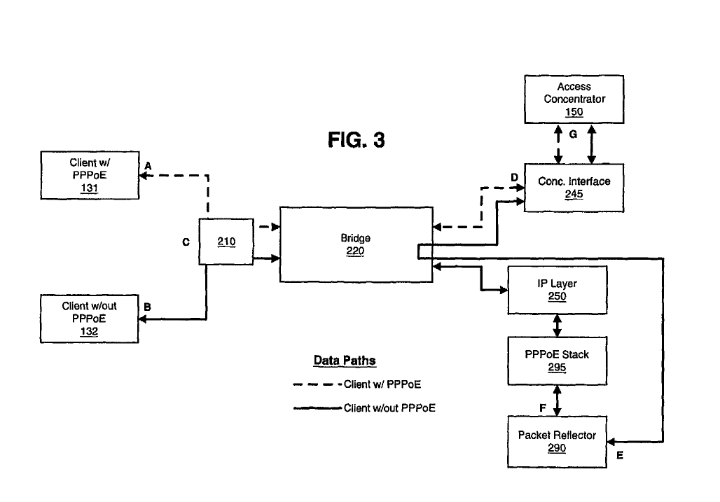

Referring now to FIG. 3, a scheme for routing frames through the gateway 110 is illustrated in accordance with at least one embodiment of the present invention. As discussed previously, in at least one embodiment, the path through the gateway 110 taken by data to/from the client 131 is different than the path taken by data to/from client 132 since the client 131 is capable of supporting a PPPoE session while the client 132 is not. Accordingly, in at least one embodiment, the bridge 220 determines the route taken by a frame based on one or more properties of the frame, such as the destination media access control (MAC) address of the frame.

As illustrated in FIG. 3, data (in the form of a frame or other logical segregation of data) is provided by the each of clients 131, 132 to the client interface 210, encapsulated/deencapsulated (if necessary), and then forwarded to the bridge 220. The bridge 220 then decapsulates the one or more frames into one or more packets and forwards the one or more packets to either the concentrator interface 245 or the IP stack 250 based on the destination MAC addresses of the one or more frames. In one embodiment, frames having a destination address other than a MAC address of an interface to the bridge 220 are forwarded to the appropriate interface for transmission to the desired destination. However, frames having a destination MAC address of one or more of the interfaces attached to the bridge are automatically forwarded to the IP stack 250. To illustrate, assume that client 131 has MAC address A, client 132 has MAC address B, the client interface 210 has MAC address C, the concentrator interface 245 has MAC address D, the frame reflector has a MAC address E attached to the bridge 220 and a MAC address F attached to the PPPoE stack 295, and the access concentrator 150 has the MAC address G. As illustrated in FIG. 3, the interfaces to the bridge 220 have MAC addresses C (concentrator interface 245), D (concentrator interface 245), and E (frame reflector 290). Accordingly, in one embodiment, any frame received at the bridge 220 that has a destination MAC address of C, D, or E is automatically forwarded by the bridge to the IP stack 250. However, frames having destination MAC addresses other than MAC address C, D, E are forwarded by the bridge 220 to the appropriate interface for transmission to the component having the destination MAC address. By forwarding frames in this way, the packets from the client 131 and client 132 can be processed by the gateway 110 as necessary.

To illustrate, in one embodiment, when the client 131 initiates a PPPoE session, it determines the MAC address of the access concentrator 110, such as by transmitting a broadcast request for any available access concentrator. Accordingly, any subsequent frames transmitted from client 131 intended for the access concentrator 110 are have a destination MAC address of the MAC address G of the access concentrator. When the bridge 220 receives frames from the client 131, the bridge 220, in one embodiment, forwards the frames to the concentrator interface 245 since the bridge 220 knows, based on a forwarding table and the like, that the concentrator interface 245 is used to transmit frames having a destination MAC address G (of the access concentrator 150). Likewise, frames transmitted from the access concentrator 150 to the client 131 have the destination MAC address A of the client 131. Accordingly, when the frames are received at the concentrator interface 245 and provided to the bridge 220, the bridge 220 forwards the frames to the client interface 210 since the bridge 220 knows, via a forwarding table, that the client interface 210 is used to transmit frames having the destination MAC address A or B.

However, since the non-PPPoE client 132 is unable to determine the MAC address of the access concentrator 150, the client 132 treats the gateway as a router and transmits frames intended for the network 160 the client interface 210, where the frames have a destination MAC address C (of the client interface 210). The client interface 210 decapsulates the frames, if necessary, and provides the frames to the bridge 220. Since the destination address of the frames remain unaltered and are therefore still addressed to MAC address C, the bridge 220 automatically deencapsulates the frames into packets and forwards the packets to the IP stack 250 since MAC address C of the frames/packets is the MAC address of an interface attached to the bridge.

The IP stack 250, noting the destination IP address of the packets, routes the packets to the PPPOE stack 295, whereupon the packets are encapsulated into PPPoE-compliant frames having the destination MAC address G of the access concentrator 150 and provided to the bridge 220 via the frame reflector 290. Because devices attached to the bridge 220 typically are required to have MAC addresses which are used by the bridge 220 to forward packets, the frame reflector 290, in one embodiment, supplies a MAC address E to the bridge 220 when the frame reflector 290 attaches to the bridge 220 and a MAC address F to the PPPoE stack 295. The frame reflector 290 can be implemented as a hardware device, thereby having an actual MAC address. Alternatively, in one embodiment, the frame reflector 290 is implemented as executable instructions, such as a device driver, that simulates a hardware device by providing a simulated MAC address to the bridge 220. Mechanisms and methods to simulate a hardware device using a simulated MAC address are known to those skilled in the art.

Alternatively, rather than routing the packets based on their destination IP addresses, the IP stack 250 can be adapted to route any packet received from the bridge 220 to the PPPoE stack 295 by default. The bridge 220, noting that the destination MAC address of the frames is MAC address G and not MAC addresses C, D, or E, forwards the frames to the concentrator interface 245, the bridge 220 forwards the frames to the concentrator interface 245 associated with the access concentrator 150 for transmission to the access concentrator 150.

Conversely, frames intended for the client 132 from the access concentrator 150 have the destination MAC address F of the frame reflector 290. Upon receipt of these frames, the concentrator interface 245 provides the frames to the bridge 220. The bridge 220, based on the destination MAC address F of the frames, forwards the frames to the frame reflector 290, since the frame reflector 290 is associated with MAC address F in the forwarding table of the bridge 220. The frame reflector 290 receives the frames from the bridge 220 and forwards them to the PPPoE stack 295. The PPPoE stack 295 deencapsulates the frames, removing the PPPoE/PPP header(s) and associated data, and provides the resulting frames to the IP stack 250. The IP stack 250, having MAC address information of locally-connected hosts to the gateway 110 (i.e., clients 131 and 132) and noting the intended destination (client 132), assigns the MAC address A to the destination MAC address of the packets, encapsulates the packets as frames, and routes the frames to the bridge 220. The bridge 220 then forwards the frames to the client interface 210 based on the destination MAC address A of the frames and the forwarding table of the bridge 220. As a result, both PPPoE clients and non-PPPoE clients may use the gateway 110 to communicate with a network via one or more access concentrators.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims and equivalents thereof.

what is claimed is:

1. A method for providing data from a client to an access concentrator using a gateway, the method comprising the steps of:
receiving, at a gateway, a non-PPPoE frame from the client, wherein the non-PPPoE frame includes data intended for receipt by the access concentrator;
encapsulating, at the gateway, the first non-PPPoE frame to generate a PPPoE frame, wherein the PPPoE frame includes the data intended for receipt by the access concentrator; and
providing the PPPoE frame to the access concentrator from the gateway.

2. The method of claim 1, further comprising the step of initiating a PPPoE session between the gateway and the access concentrator for the client.

3. The method of claim 1, wherein the non-PPPoE frame includes an IP packet.

4. The method of claim 1, wherein the gateway includes one of a group consisting of: a digital subscriber line modem, a cable modem, a router, and a wireless access point.

5. The method of claim 1, wherein receiving the non-PPPoE frame from the client includes the steps of:
receiving, at an input interface, the non-PPPoE frame from the client;
providing the non-PPPoE frame to a bridge;
forwarding the non-PPPoE frame to a PPPoE stack from the bridge.

6. The method of claim 5, wherein the input interface includes an Ethernet interface.

7. The method of claim 5, wherein modifying the non-PPPoE frame to generate a PPPoE frame includes the steps of:
adding, at the PPPoE stack, a PPP header to the non-PPPoE frame to generate a PPPoE frame; and
adding, at the PPPOE stack, a PPPoE header to the PPPoE frame to generate a PPPoE frame.

8. The method of claim 7, wherein providing the PPPoE frame to the access concentrator includes the steps of:
providing the PPPoE frame from the PPPoE stack to a frame reflector;
providing the PPPOE frame from the frame reflector to the bridge; and
providing the PPPoE frame from the bridge to an output interface for output to the access concentrator.

9. The method of claim 8, wherein the output interface includes a UTOPIA interface.

10. The method of claim 9, wherein the output interface further includes a RFC 1483 interface.

11. The method of claim 1, further comprising the steps of:
receiving, at the gateway, a PPPoE frame from the access concentrator, wherein the PPPoE frame includes data intended for receipt by the client;
modifying, at the gateway, the PPPoE frame to generate a non-PPPoE frame, wherein the non-PPPoE frame includes the data intended for receipt by the client; and
providing the non-PPPoE frame to client from the gateway.

12. A method for providing data from an access concentrator to a non-PPPoE client using a gateway, the method comprising the steps of:
receiving, at a gateway, a PPPOE frame from the access concentrator, wherein the PPPoE frame includes data intended for receipt by the client;
deencapsulating, at the gateway, the PPPoE frame to generate a non-PPPoE frame, wherein the non-PPPoE frame includes the data intended for receipt by the client; and
providing the non-PPPoE frame to the client from the gateway.

13. The method of claim 12, further comprising the step of initiating a PPPoE session between the gateway and the access concentrator for the client.

14. The method of claim 12, wherein the non-PPPoE frame includes an IP packet.

15. The method of claim 12, wherein the gateway includes one of a group consisting of: a digital subscriber line modem, a cable modem, a router, and a wireless access point.

16. The method of claim 12, wherein receiving the PPPoE frame from the access concentrator includes the steps of:
receiving, at an input interface, the PPPoE frame from the access concentrator;
providing the PPPoE frame to a bridge; and
providing the PPPoE frame from the bridge to a PPPoE stack using a frame reflector.

17. The method of claim 16, wherein the input interface includes a UTOPIA interface.

18. The method of claim 17, wherein the input interface further includes a RFC 1483 interface.

19. The method of claim 16, wherein the step of deencapsulating the PPPoE frame to generate a non-PPPoE frame includes the steps of:
removing, at the PPPoE stack, a PPPoE header from the PPPoE frame to generate a PPP frame; and
removing, at the PPPoE stack, a PPP header from the PPP frame to generate a non-PPPoE frame.

20. The method of claim 16, wherein providing the non-PPPoE frame to the client includes the steps of:
providing the non-PPPoE frame from the PPPoE stack to the frame reflector;
providing the non-PPPoE frame from the frame reflector to the bridge; and
providing the non-PPPoE frame from the bridge to an output interface for output to the client.

21. The method of claim 20, wherein the output interface includes an Ethernet interface.

22. A method for transporting data among clients and access concentrators, the method comprising the steps of:
receiving, at a bridge, a first frame having a PPPoE format from a first client, wherein the first frame is intended for receipt by an access concentrator;
receiving, at the bridge, a second frame having a non-PPPoE format from a second client, wherein the second frame is intended for receipt by an access concentrator;
providing, from the bridge, the first frame to an interface for output to an access concentrator;
providing, from the bridge, the second frame as an IP packet to an IP stack;
routing the IP packet to a PPPoE stack;
encapsulating, at the PPPoE stack, the IP packet into a third frame having a PPPoE format; and
providing the third frame to the interface for output to an access concentrator.

23. The method of claim 22, wherein the first client is adapted to support a PPPoE session and the second client is not adapted to support a PPPoE session.

24. The method of claim 22, wherein the first frame and the second frame are intended for receipt by a same access concentrator.

25. The method of claim 22, wherein providing the first frame to the interface includes the steps of:
determining a destination media access control address of the first frame; and
providing the first frame to the interface when the destination media access control address of the first frame includes a media access control address of a network device accessible by the interface.

26. The method of claim 25, wherein providing the second frame as the IP packet to the IP stack includes the steps of:
determining a destination media access control address of the second frame; and
providing the second frame as the IP packet to the IP stack when the destination media access control address of the second frame is an media access control address of an interface attached to the bridge.

27. The method of claim 22, wherein encapsulating the IP packet to generate the third frame includes the steps of:
adding a PPP header to the IP packet to generate a modified frame; and
adding a PPPoE header to the modified frame to generate the third frame.

28. The method of claim 27, wherein providing the third frame includes the steps of:
assigning a destination media access control address to the third frame corresponding to a media access control address of a frame reflector used to transmit the third frame between the PPPoE stack and the bridge;
providing the third frame to the bridge using the frame reflector; and
providing, at the bridge, the third frame to the output interface based on the destination media access control address of the third frame.

29. The method of claim 22, further comprising the steps of:
receiving, at the bridge, a fourth frame having a PPPoE format from an access concentrator, wherein the fourth frame from the access concentrator is intended for receipt by the first client, and where the first client is adapted to receive frames having the PPPoE format;
receiving, at the bridge, a fifth frame having a PPPoE format from the access concentrator, wherein the fifth frame is intended for receipt by the second client, and where the second client is adapted to receive frames having a non-PPPoE format;
providing, from the bridge, the fourth frame to an interface for output to the first client;
providing, from the bridge, the fifth frame to a PPPoE stack using a frame reflector;
deencapsulating, at the PPPoE stack, the fifth frame to generate a sixth frame having the non-PPPoE format; and
providing the sixth frame to the interface for output to the second client.

30. A system comprising:
a first interface adapted to receive a first frame having a non-PPPoE format from a first client and to provide a second frame having a non-PPPoE format to the first client;
a second interface adapted to receive a third frame having a PPPoE format from an access concentrator and to provide a fourth frame having a PPPoE format to the access concentrator;
a PPPoE stack adapted to encapsulate the first frame having a non-PPPoE format into the fourth frame having a PPPoE format, and wherein the PPPoE stack further is to deencapsulate the third frame having a PPPoE format into the second frame having a non-PPPoE format;
a bridge coupled to the first interface and the second interface, wherein the bridge is adapted to provide the fourth frame to the second interface for output to the access concentrator and to provide the second frame to the first interface for output to the first client;
an IP stack coupled to the PPPoE stack and the bridge, wherein the IP stack is adapted to route the first frame from the bridge to the PPPoE stack and to route the second frame from the PPPoE stack to the bridge; and
a frame reflector coupled to the PPPoE stack and the bridge, wherein the frame reflector is adapted to provide the fourth frame to the bridge from the PPPoE stack and to provide the first frame from the bridge to the PPPoE stack.

31. The system of claim 30, wherein the first interface includes an Ethernet interface.

32. The system of claim 30, wherein the second interface includes a UTOPIA interface.

33. The system of claim 32, wherein the second interface further includes a RFC 1483 interface.

34. The system of claim 30, wherein the PPPoE stack includes:
a PPP client layer coupled to the bridge, wherein the PPP client layer is adapted to initiate a PPPoE session between the PPP client layer and the access concentrator, and where the PPP client layer is adapted to add a PPP header to the first frame and to remove a PPP header from the third frame; and
a PPPoE client layer coupled to the PPP client layer and to the frame reflector, wherein the PPPoE client layer is adapted to add a PPPoE header to the first frame and to remove a PPPoE header from the third frame.

35. The system of claim 30, wherein:
the first interface includes a first media access control address;
the second interface includes a second media access control address;
the frame reflector includes a third and fourth media access control address; and
wherein the bridge is adapted to route the first frame, the second frame, the third frame, and the fourth frame based on a destination media access control address of each frame.

36. In a distributed network comprising a plurality of clients in communication with at least one gateway over a network and in communication with at least one access concentrator via the gateway, the gateway comprising:
a first interface adapted to receive a first non-PPPoE frame from a first client and to provide a second non-PPPoE frame to the first client;
a second interface adapted to provide a first PPPoE frame to an access concentrator and to receive a second PPPoE frame from the access concentrator;
a means for encapsulating the first non-PPPoE frame to generate the first PPPoE frame; and
a means for deencapsulating the second PPPoE frame to generate the second non-PPPoE frame.

37. The gateway of claim 36, wherein:
the first interface further is adapted to receive a third PPPoE frame from a second client and to provide a fourth PPPoE frame to the second client;
the second interface further is adapted to receive the fourth PPPoE frame from an access concentrator and to provide the third PPPoE frame to the access concentrator.

38. The gateway of claim 37, further comprising:
a means for providing the third PPPoE frame from the first interface to the second interface; and
a means for providing the fourth PPPoE frame from the second interface to the first interface.

39. The gateway of claim 36, wherein the first interface includes an Ethernet interface.

40. The gateway of claim 36, wherein the second interface includes a UTOPIA interface.

41. The gateway of claim 36, wherein the second interface further includes a RFC 1483 interface.
